(19) United States
(12) Patent Application Publication
(10) Pub. No.: US 2025/0190798 A1
(43) Pub. Date: Jun. 12, 2025

(54) Systems and methods for transformers with merged linear layers

(71) Applicant: Nils Graef, Dublin, CA (US)

(72) Inventor: Nils Graef, Dublin, CA (US)

(21) Appl. No.: 18/977,974

(22) Filed: Dec. 12, 2024

Related U.S. Application Data
(60) Provisional application No. 63/609,293, filed on Dec. 12, 2023.

(51) Int. Cl. G06N 3/082; G06N 3/045

(52) U.S. Cl. CPC G06N 3/082; G06N 3/045

(57) ABSTRACT

Methods and systems are provided to reduce the number of parameters (weights) and to enhance the computational efficiency of transformer neural network models for machine learning and generative artificial intelligence. In one embodiment, one or more projection layers of the transformer's attention networks are eliminated by merging them into preceding and/or succeeding projection layers of the feedforward networks. For transformer models without skip connections, this merging of linear layers is done in a mathematically equivalent way without changing the overall functionality and accuracy of the original neural network model.

One embodiment of the method of merging a first linear layer into a second linear layer (or vice versa) involves replacing the weight matrix of the second linear layer by the matrix product (computed by matrix multiplication) of the two weight matrices so as to eliminate the first linear layer (or vice versa).

### CROSS-REFERENCE TO RELATED APPLICATIONS

This application claims priority to the U.S. Provisional Application No. 63/609,293, filed on Dec. 12, 2023. The entire contents of the foregoing provisional application is hereby incorporated by reference.

### PRIOR ART

Bobby H e, Thomas Hofmann. “Simplifying Transformer Blocks,” arXiv 2311.01906, 2023.
Ashish Vaswani, Noam Shazeer, et al. “Attention is all you need,” Advances in neural information processing systems, 2017. arXiv 1706.03762, 2017.
Noam Shazeer. “Fast transformer decoding: One write-head is all you need,” arXiv 1911.02150, 2019.
Joshua Ainslie et al. “Training Generalized Multi-Query Transformer Models from Multi-Head Checkpoints,” arXiv 2305.13245, 2023.
Wang, B. and Komatsuzaki. “A. GPT-J-6B: A 6 billion parameter autoregressive language model”, Wikipedia https://en.wikipedia.org/wiki/GPT-J, 2021.
Jimmy Ba et al. “Layer normalization,” arXiv 1607.06450, 2016.
Biao Zhang and Rico Sennrich. “Root mean square layer normalization,” NeurIPS, 2019. arXiv 1910.07467, 2019.
Ruibin Xiong et al. “On Layer Normalization in the Transformer Architecture,” arXiv 2002.04745, 2020.
Lorenzo Noci et al. “The shaped transformer: Attention models in the infinite depth-and-width limit,” arXiv 2306.17759, 2023.
Bobby He et al. “Deep Transformers without Shortcuts: Modifying Self-attention for Faithful Signal Propagation,” ICLR, 2023. arXiv 2302.10322, 2023.
Stella Biderman, Hailey Schoelkopf, et al. “Pythia: A suite for analyzing large language models across training and scaling,” arXiv 2304.01373, 2023.
Hugo Touvron et al. “Llama 2: Open foundation and fine-tuned chat models,” arXiv 2307.09288, 2023.
Albert Q Jiang et al. “Mistral 7B,” arXiv 2310.06825, 2023.
Noam Shazeer. “GLU Variants Improve Transformer,” arXiv 2002.05202, 2020.
Wikipedia “Invertible matrix”, https://en.wikipedia.org/wiki/Invertible_matrix Accessed March-2024.

### BACKGROUND OF THE INVENTION

Transformer models are at the heart of generative AI (artificial intelligence) and machine learning. These models often involve substantial computational and memory costs due to their large number of weights (parameters). Therefore, there exists a need to reduce the number of weights and enhance the computational complexity of transformer neural network architectures. Reducing the number of weights in such architectures leads to higher computational efficiency, lower latency, higher throughput, smaller memories, and lower cost per token.

Existing methods for simplifying transformers, such as those described by Bobby He and Thomas Hofmann in “Simplifying Transformer Blocks” (arXiv preprint arXiv: 2311.01906, 2023), focus on specific types of attention mechanisms but are not universally applicable to multi-query attention (MQA) or grouped-query attention (GQA), which are widely employed in large language models (LLMs) like Llama 2 and Mistral. Therefore, there exists a need for simplified transformer architectures that are applicable to various attention mechanisms including MQA, GQA, and MHA (multi-head attention).

### SUMMARY OF THE INVENTION

This specification describes various systems and methods for modified and simplified transformer neural network architectures with and without skip connections (aka residual connections) that are suitable for various types of attention mechanisms including MHA, MQA, and GOA. The modified architectures reduce the number of weights while maintaining functionality and model accuracy and are mainly derived by merging and eliminating one or more linear layers (also known as fully-connected layers, dense layers, or projection layers) of the transformer architecture.

By merging and eliminating certain projection linear layers, the architectures described in this specification achieve significant weight reductions. For example, eliminating the attention query (Q) projection layers and the post-attention output projection (P) layers from a skipless version of Mistral-7B removes 15% of its weights and thus reduces its compute and memory complexity.

### BRIEF DESCRIPTION OF DRAWINGS

FIG. 1. depicts (a) a transformer block without skip connections and without normalization layers, as well as optimized versions with (b) projections Q and P merged into the FFN (feedforward network); (c) projections K and P merged into the FFN; and (d) projections V and P merged into the FFN, where Q, K, V, P denote the attention query, key, value, and post-attention output projections, and M and O denote the first and second stage of projection layers of the FFN.

FIG. 2. illustrates how linear layers are merged (or collapsed). Specifically, FIG. 2(a) shows how the linear layer P is merged into linear layer M; FIG. 2(b) shows how the linear layer Q is merged into linear layer O; FIG. 2(c) shows how the linear layer K is merged into linear layer O; and FIG. 2(d) shows how the linear layer V is merged into linear layer O.

FIG. 3 shows parallel versions of FIG. 1(b) and FIG. 1(c), where the attention network and feedforward network are processed in parallel.

FIG. 4 shows alternative embodiments with skip connections. Specifically, FIG. 4(a) shows a transformer block without projections Q and P; and FIG. 4(b) shows a parallel version where the attention network and the feedforward network are processed in parallel.

### DETAILED DESCRIPTION OF THE INVENTION

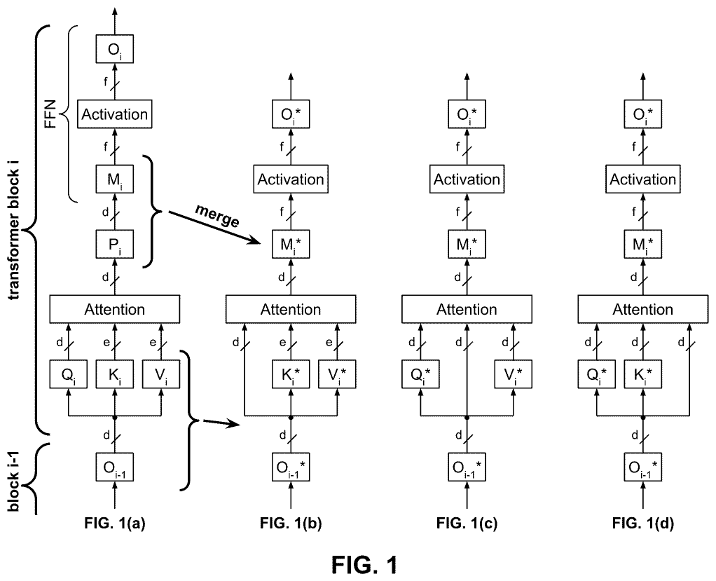

Bobby He et al. detailed in “Deep Transformers without Shortcuts: Modifying Self-attention for Faithful Signal Propagation” (ICLR, 2023. arXiv preprint arXiv: 2302.10322, 2023) how transformer neural networks without skip connections and normalization layers can be successfully trained. FIG. 1(a) shows a transformer without skip connections and normalization layers.

The removal of the skip connections and normalization layers enables linear layers to be merged (or collapsed) in a mathematically equivalent way as shown in FIG. 1(b) to FIG. 1(d). This reduces the number of weights without changing the functionality and model accuracy as follows, where Qⱼ, Kᵢ, Vᵢ, Pᵢ are the weight matrices of the attention linear layers for query, key, value, and the post-attention output projections of transformer block i, and Mᵢ and Oᵢ are the weight matrices of the first and second stage of projection layers of the FFN (feedforward network) of transformer block i:

FIG. 1(b) is mathematically identical to FIG. 1(a) and eliminates 2 [symbol] d² weights per transformer block by merging Pᵢ into Mᵢ* and Qᵢ into Oᵢ₋₁*.

For MHA (multi-head attention) where e=d, FIG. 1(c) and FIG. 1(d) are mathematically identical to FIG. 1(a) and eliminate 2 [symbol] d² weights per transformer block by merging Pᵢ into Mᵢ* and Kᵢ or Vᵢ into Oᵢ₋₁*.

In total, we can eliminate up to two of the four attention linear layers (Q, K, V, P).

The merging of linear layers described above requires that Qⱼ, Kᵢ, and Vᵢ are invertible (i.e. nonsingular). It is extremely rare that a square matrix with random values is not invertible, which requires its determinant to be exactly 0.

FIG. 1 uses the following dimensions and weight matrices, based on the type of attention such as multi-head attention (MHA), multi-query attention (MQA), and grouped-query attention (GQA):

Dimension d is the embedding dimension. And dimension e is the output dimension of the key (K) and value (V) linear layers, where e=d holds for MHA. For MQA, e=d/n_heads holds. And for GQA, e=d*n_kv_heads/n_heads holds.

Dimension f is the hidden dimension of the FFN (feedforward network, aka MLP or multi-layer perceptron). f=4 [symbol] d in the original transformer; but oftentimes f>4 [symbol] d. For models that use a GLU variant (such as transformer models Llama 2 and Mistral), the effective f for the first linear layer M is f=2 [symbol] f, because the GLU variant uses two linear layers that are combined (via pointwise multiplication) with a non-linear activation function.

The blocks labeled “attention” in all figures of this specification refer to any type of attention such as scaled dot-product attention and shaped attention (see for example Lorenzo Noci et al. “The shaped transformer: Attention models in the infinite depth-and-width limit,” arXiv preprint arXiv: 2306.17759, 2023), as well as MHA, MQA, and GQA.

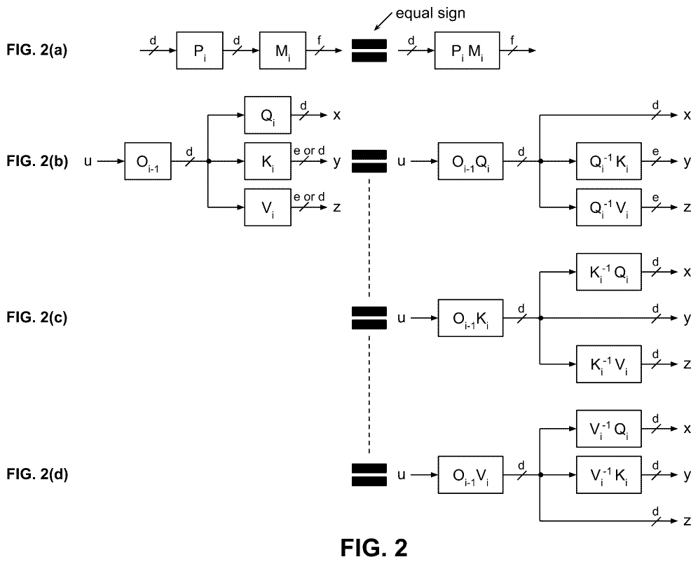

FIG. 2 details how the linear layers are merged (or collapsed): Specifically, FIG. 2(a) shows how the two linear layers with weight matrices Pᵢ and Mᵢ are collapsed and replaced by a single linear layer with weight matrix Mᵢ*=Pᵢ Mᵢ (where Pᵢ Mᵢ is the matrix multiplication of matrices Pᵢ and Mᵢ), which eliminates d² weights and about 2d² operations per token per transformer block (the factor 2 comes from counting a multiply-and-add operation as two operations, which is commonly done when expressing computational complexity).

FIG. 2(b) illustrates how to merge Q into the preceding Oᵢ₋₁ matrix, which requires Qᵢ to be invertible, and which eliminates d² weights and about 2d² operations per token per transformer block. Note that y=u Oᵢ₋₁ (Qᵢ Qᵢ⁻¹) Kᵢ=u Oᵢ₋₁ Kᵢ and z=u Oᵢ₋₁ (Qᵢ Qᵢ⁻¹) Vᵢ=u Oᵢ₋₁ Vᵢ, where matrix Qᵢ⁻¹ is the inverse of Qⱼ.

For MHA where e=d holds, Kᵢ can be removed as shown in FIG. 2(c), which eliminates d² weights and about 2d² operations per token per transformer block. Note that x=u Oᵢ₋₁ (Kᵢ Kᵢ⁻¹) Qᵢ=u Oᵢ₋₁ Qᵢ and z=u Oᵢ₋₁ (Kᵢ Kᵢ⁻¹) Vᵢ=u Oᵢ₋₁ Vᵢ. This requires that Kᵢ is invertible.

For MHA where e=d holds, Vᵢ can be eliminated as shown in FIG. 2(d), which eliminates d² weights and about 2d² operations per token per transformer block. Note that x=u Oᵢ₋₁ (Vᵢ Vᵢ⁻¹) Q=u Oᵢ₋₁ Qᵢ and y=u Oᵢ₋₁ (Vᵢ Vᵢ⁻¹) Kᵢ=u Oᵢ₋₁ Kᵢ. This requires that Vᵢ is invertible.

Note that for multi-query attention (MQA) and grouped-query attention (GQA), eliminating K or V is not possible (because here dimension e doesn't equal d). In this case, eliminating Q is the only possibility, which also saves more compute and weights because Q is h times larger than K or V for MQA, where h is the number of attention heads. Specifically, note that FIG. 2(b) is suitable for MHA, MQA, and GOA. However, FIG. 2(c) and FIG. 2(d) are only suitable for MHA, but not suitable for MQA and GQA because they require e=d.

The table below specifies how the new weight matrices (Mᵢ*, Qᵢ*, Kᵢ*, Vᵢ*, Oᵢ₋₁*) of FIG. 1 are calculated from the original ones. For the first transformer block (i=1), we use the input embedding matrix instead of Oᵢ₋₁ (because there is no Oᵢ₋₁ for i=1).

| | FIG. 1(b) | FIG. 1(c) | FIG. 1(d) |
|---|---|---|---|
| Oᵢ₋₁* | Oᵢ₋₁ [symbol] Qᵢ | Oᵢ₋₁ [symbol] Kᵢ | Oᵢ₋₁ [symbol] Vᵢ |
| Qᵢ* | 1 (eliminated) | Kᵢ⁻¹ [symbol] Qᵢ | Vᵢ⁻¹ [symbol] Qᵢ |
| Kᵢ* | Qᵢ⁻¹ [symbol] Kᵢ | 1 (eliminated) | Vᵢ⁻¹ [symbol] Kᵢ |
| Vᵢ* | Qᵢ⁻¹ [symbol] Vᵢ | Kᵢ⁻¹ [symbol] Vᵢ | 1 (eliminated) |

| | |
|---|---|
| Mᵢ* | Pᵢ [symbol] Mᵢ |

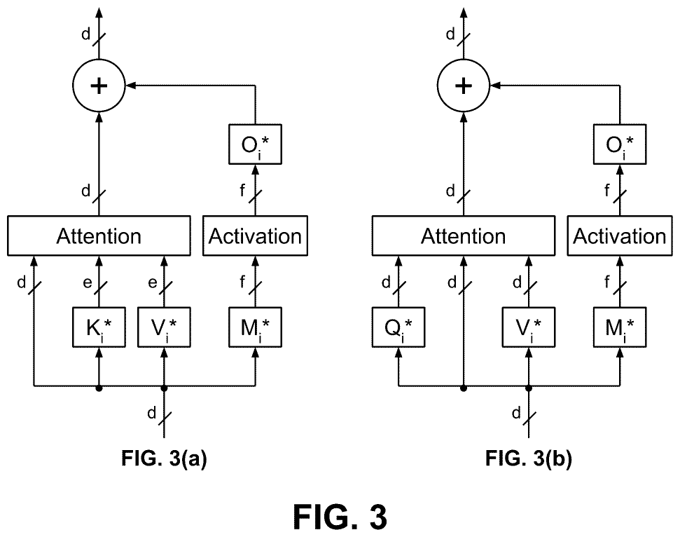

Similar to the parallel transformer (see for example Wang, B. and Komatsuzaki. “A. GPT-J-6B: A 6 billion parameter autoregressive language model”), FIG. 3 shows parallel versions of FIG. 1(b) and FIG. 1(c). Here, “parallel” refers to processing the attention network (including its linear projection layers) in parallel to the feedforward network (FFN).

FIG. 3(b) requires that e=d, so it is only suitable for MHA, but not for MQA and GQA. FIG. 3(a) is suitable for MHA, MQA, and GQA.

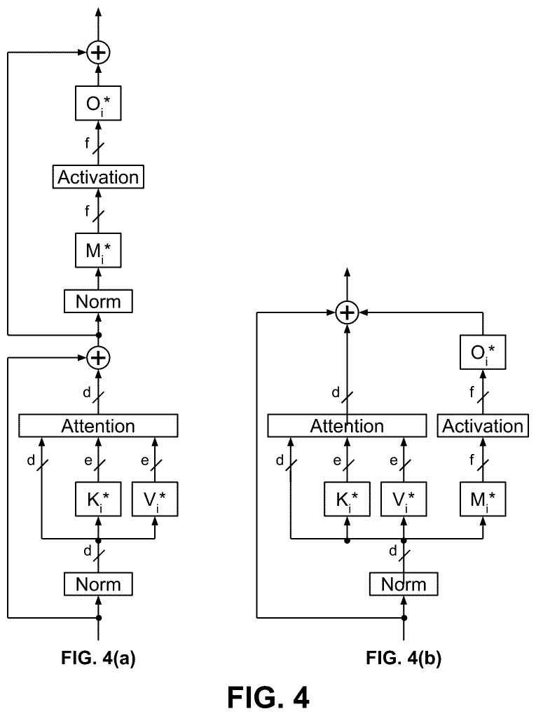

Alternative embodiments of this invention include versions with skip connections and normalization layers, as shown in FIG. 4. Adding normalization layers and skip connections can simplify and speed up training relative to skipless transformers.

So far we have shown architectures without normalization layers, such as layer normalization and RMS normalization. In general, normalization can be added before the attention network and feedforward network (which is known as Pre-LN or Pre-Norm) or after the attention network and the feedforward network (known as Post-LN or Post-Norm). Similarly, normalization layers can be added anywhere to the architectures detailed in the preceding sections.

For example, FIG. 4(a) shows a modified version of FIG. 1(b) with skip connections and with normalization layers added before the attention network and before the feedforward network (pre-norm). Similarly, FIG. 4(b) is a modified version of FIG. 3(a) with skip connections and with normalization added before attention network and the feedforward MLP (pre-norm).

Practical examples are provided in the table below, which lists the configurations and number of weights (or parameters) for the transformer models Pythia-6.9B and Mistral-7B. A skipless version of Mistral-7B saves 15% of its weights after merging the Q and P linear layers into the FFN layers. For a batch-size 1 system that is limited by memory bandwidth, these 15% weight savings can speed up inference by 1.17× during the autoregressive next-token-generation phase as detailed in the table below.

| Parameter | Pythia-6.9B | Mistral-7B | Notes |
|---|---|---|---|
| Parallel attn./FFN? | parallel | serial | |
| MHA, MQA, or GQA? | MHA | GQA | |
| dim (aka d) | 4,096 | | embedding dimension |
| n_layers | 32 | | number of transformer layers (aka |
| | | | number of transformer blocks) |
| n_heads | 32 | | number of heads |
| n_kv_heads | 32 | 8 | number of KV-heads |
| e (output dim. of K, V) | 4,096 | 1,024 | e = d * n_kv_heads/n_heads |
| FFN hidden_dim | 16,384 | 14,336 | FFN hidden dimension |
| vocab_size | 50,400 | 32,000 | vocabulary size |

Number of weights calculated from above parameters:

| Q + P weights per layer | 33,554,432 | | 2 * (dim)² |
|---|---|---|---|
| K + V weights per layer | 33,554,432 | 8,388,608 | 2 * (dim)²/n_heads * n_kv_heads |
| FFN weights per layer | 134,217,728 | 176,160,768 | (2 or 3) * dim * hidden_dim |
| Input + output embed. | 412,876,800 | 262,144,000 | 2 * dim * vocab_size |
| Total weights: | 6.9B | 7.2B | |

Weight savings and speedup after elimination of linear layers Q and P:

| | | | |
|---|---|---|---|
| Total w/o Q + P weights: | 5.8B | 6.2B | total after elimination of Q and P |
| Weight savings: | 16% | 15% | |
| Speedup: | 1.19 x | 1.17 x | assumes batch size 1 |

1. A method for reducing computational complexity and a system comprising one or more computers and one or more storage devices storing instructions that when executed by the one or more computers implement a modified transformer neural network comprising of one or more transformer blocks without skip connections (or residual connections); wherein each transformer block comprises one or more attention networks and one or more feedforward networks; wherein the post-attention projection linear layer of one or more attention networks is merged into the first stage of linear layers of the succeeding feedforward network in a mathematically equivalent way so as to reduce the number of weights and computational operations without changing the overall functionality and accuracy of the original neural network model; and wherein the method of merging a first linear layer into a second linear layer (or vice versa) involves replacing the weight matrix of the second linear layer by the matrix product (computed by matrix multiplication) of the two weight matrices so as to eliminate the first linear layer (or vice versa).

2. The system of claim 1, wherein one or more attention query (Q) projection linear layers are further merged with the last linear layers of their respective preceding feedforward networks in a mathematically equivalent way so as to reduce the number of weights and operations by eliminating the query (Q) projection layers; and wherein the attention key (K) and value (V) projection layers are changed to compensate for the eliminated query (Q) projection layers by replacing the original weight matrices of the attention key (K) and value (V) projection layers by the matrix product of the inverse of the eliminated query (Q) weight matrix and the original key (K) or value (V) weight matrix, respectively.

3. The system of claim 1, wherein one or more attention key (K) projection linear layers are further merged with the last linear layers of their respective preceding feedforward networks in a mathematically equivalent way so as to reduce the number of weights and operations by eliminating the key (K) projection layers; and wherein the attention query (Q) and value (V) projection layers are changed to compensate for the eliminated key (K) projection layers by replacing the original weight matrices of the attention query (Q) and value (V) projection layers by the matrix product of the inverse of the eliminated key (K) weight matrix and the original query (Q) or value (V) weight matrix, respectively.

4. The system of claim 1, wherein one or more attention value (V) projection linear layers are further merged with the last linear layers of their respective preceding feedforward networks in a mathematically equivalent way so as to reduce the number of weights and operations by eliminating the value (V) projection layers; and wherein the attention query (Q) and key (K) projection layers are changed to compensate for the eliminated value (V) projection layers by replacing the original weight matrices of the attention query (Q) and key (K) projection layers by the matrix product of the inverse of the eliminated value (V) weight matrix and the original query (Q) or key (K) weight matrix, respectively.

5. The system of claim 1, wherein one or more transformer blocks further comprise a parallel configuration (instead of a serial configuration) of the attention network and feedforward network to optimize processing speed, wherein the inputs of the attention network and the feedforward network are both connected to the input of the transformer block, and wherein the outputs of the two networks are pointwise added and the resulting sums comprise the output of the transformer block.

6. The system of claim 2, wherein one or more transformer blocks further comprise a parallel configuration (instead of a serial configuration) of the attention network and feedforward network to optimize processing speed, wherein the inputs of the attention network and the feedforward network are both connected to the input of the transformer block, and wherein the outputs of the two networks are pointwise added and the resulting sums comprise the output of the transformer block.

7. The system of claim 3, wherein one or more transformer blocks further comprise a parallel configuration (instead of a serial configuration) of the attention network and feedforward network to optimize processing speed, wherein the inputs of the attention network and the feedforward network are both connected to the input of the transformer block, and wherein the outputs of the two networks are pointwise added and the resulting sums comprise the output of the transformer block.

8. A method for reducing computational complexity and a system comprising one or more computers and one or more storage devices storing instructions that when executed by the one or more computers implement a modified transformer neural network comprising of one or more transformer blocks with skip connections (or residual connections) and normalization layers; wherein each transformer block comprises one or more attention networks and one or more feedforward networks; wherein the post-attention projection linear layer of one or more attention networks is merged into the first stage of linear layers of the succeeding feedforward network so as to eliminate the post-attention projection linear layer to reduce the number of weights and computational operations.

9. The system of claim 8, wherein one or more attention query (Q) projection linear layers are further merged with the last linear layer of their respective preceding feedforward networks so as to reduce the number of weights and operations by eliminating the query (Q) projection layers.

10. The system of claim 8, wherein one or more attention key (K) projection linear layers are further merged with the last linear layer of their respective preceding feedforward networks so as to reduce the number of weights and operations by eliminating the key (K) projection layers.

11. The system of claim 8, wherein one or more attention value (V) projection linear layers are further merged with the last linear layer of their respective preceding feedforward networks so as to reduce the number of weights and operations by eliminating the value (V) projection layers.

12. The system of claim 8, wherein one or more transformer blocks further comprise a parallel configuration (instead of a serial configuration) of the attention network and feedforward network to optimize processing speed, wherein the inputs of the attention network and the feedforward network are both connected to the input of the transformer block, and wherein the outputs of the two networks are pointwise added and the resulting sums comprise the output of the transformer block.

13. The system of claim 9, wherein one or more transformer blocks further comprise a parallel configuration (instead of a serial configuration) of the attention network and feedforward network to optimize processing speed, wherein the inputs of the attention network and the feedforward network are both connected to the input of the transformer block, and wherein the outputs of the two networks are pointwise added and the resulting sums comprise the output of the transformer block.

14. The system of claim 10, wherein one or more transformer blocks further comprise a parallel configuration (instead of a serial configuration) of the attention network and feedforward network to optimize processing speed, wherein the inputs of the attention network and the feedforward network are both connected to the input of the transformer block, and wherein the outputs of the two networks are pointwise added and the resulting sums comprise the output of the transformer block.

15. The system of claim 11, wherein one or more transformer blocks further comprise a parallel configuration (instead of a serial configuration) of the attention network and feedforward network to optimize processing speed, wherein the inputs of the attention network and the feedforward network are both connected to the input of the transformer block, and wherein the outputs of the two networks are pointwise added and the resulting sums comprise the output of the transformer block.
